(19) United States
(12) Patent Application Publication
(10) Pub. No.: US 2018/0012150 A1
(43) Pub. Date: Jan. 11, 2018

(54) SYSTEMS AND METHODS FOR AUTOMATICALLY PROCURING AIRLINE PRODUCTS

(71) Applicant: Options Away, Inc., Chicago, IL (US)

(72) Inventors: Heidi Alexandra Brown, Oak Park, IL (US); Francis Robert Brown, Oak Park, IL (US); Michael Patrick Harbin, Crete, IL (US)

(21) Appl. No.: 15/644,343

(22) Filed: Jul. 7, 2017

Related U.S. Application Data
(60) Provisional application No. 62/359,942, filed on Jul. 8, 2016.

(51) Int. Cl. G06Q 10/02; G06F 3/0482; G06F 3/0484; G06F 3/0488

(52) U.S. Cl. CPC G06Q 10/02; G06F 3/0488; G06F 3/0482; G06F 3/0484

(57) ABSTRACT

Aspects of the present disclosure involve a reservation system that monitors, purchases airline tickets and/or airline reservations automatically and in real-time. One or more graphical-user interfaces are generated that reduce the time it takes for a user to identify and reserve and airline ticket.

### CROSS REFERENCE TO RELATED APPLICATIONS

This application claims the priority of U.S. provisional application No. 62/359,942, filed Jul. 8, 2016, which is hereby incorporated by reference in its entirety.

### TECHNICAL FIELD

Aspects of the present disclosure relate to computing devices and hardware used in the field of transportation, particularly for use in the airlines industry.

### BRIEF DESCRIPTION OF THE DRAWINGS

The patent or application file contains at least one drawing executed in color. Copies of this patent or patent application with color drawing(s) will be provided by the Office by request and payment of the necessary fee.

The foregoing and other objects, features, and advantages of the present disclosure set forth herein will be apparent from the following description of particular embodiments of those inventive concepts, as illustrated in the accompanying drawings. Also, in the drawings the like reference characters refer to the same parts throughout the different views. The drawings depict only typical embodiments of the present disclosure and, therefore, are not to be considered limiting in scope.

FIG. 1 is a block diagram illustrating a computing architecture for procuring airline products and services, according to aspects of the present disclosure.

FIG. 2 is a flowchart of an example airline reservation lock-in process, according to aspects of the present disclosure.

FIG. 3A-3C are example airline reservation graphical-user interface screen shots, according to aspects of the present disclosure.

FIG. 4 is a block diagram illustrating a computing device, according to aspects of the present disclosure.

### DETAILED DESCRIPTION

Aspects of the present disclosure involve a reservation system that monitors, purchases airline tickets and/or airline reservations (collectively referred to as “airline products”) automatically and in real-time. In various aspects, the reservation system uses historic and/or real-time pricing information to monitor various airline products and services in order to assist in the purchasing decisions being made with respect to the airline products and/or any release decisions (e.g., cancellation, refund, or resale) being made with respect to the airline products.

The reservation system may be dynamically driven by historic and/or real-time airline ticket pricing information and related data. Using airline ticket pricing information and related airline data to dynamically drive the reservation system enables the system to make automatic and precise decisions related to the purchase and/or release of airline products and provide indications of the decisions to customers. For example, when providing pricing information for an airline ticket to a current customer, the reservation system may generate a series of notifications that indicate to the user whether the current price is generally a good price, average price, or bad price. In another example, the reservation system may provide a notification that indicates the customer should purchase the airline product(s) immediately due to immediate predicted future price increases, or delay in purchasing the airline product due to predicted future price drops. In other embodiments, the provided notifications may be provided to users in the form of an active alert, such as alerting potential customers with current and/or predicted future pricing information of an airline product. For example, the reservation system may alert a potential customer when a current price for the airline product satisfies a pre-defined price threshold.

In some embodiments, the various notifications and/or decisions may be integrated directly into a graphical-user interface generated by the system. In typical airline ticket procurement systems and interfaces, users cannot automatically reserve airline tickets and related products without providing large amounts of user-input and engaging in cumbersome interactions (e.g. web-based), which ultimately delay a user's ability to lock-in an airline ticket at a certain price. For example, typical online airline flight searching applications and interfaces require a user to engage in multiple interactions on a graphical-user interface to select the departure airport, destination, date, and price when booking an airline reservation and then a search is launched by clicking a push-button. An intermediate screen shows that the search is being performed. After a while, the search results are presented on yet another separate and distinct interface. However, in many instances a user may ultimately want to quickly, and in real-time, scan for airline ticket opportunities without providing large amounts of input and without moving between multiple graphical-user interface screens.

Various aspects of the present disclosure solve such technical issues by specifically improving the speed, accuracy, and usability of the graphical user-interfaces of an airline reservation system, thereby enabling users to obtain airline tickets in a faster manner. More specifically, the disclosed systems require a user to only provide a minimal amount of information (e.g., an initial set of parameters) as input to a graphical user-interface capable of reserving airline tickets. In response to the input, the system automatically identifies and procures (i.e., locks-in) one or more airline tickets for the user, which may be a valid reservation for a specific period of time, thereby increasing the likelihood that the user will obtain an airline ticket at a desirable price point. In one specific example, the system may automatically display or otherwise integrate a “TripWatch” component into a specific region (e.g., next to previous airline reservations, or historical airline reservation information) of the airline reservation graphical user-interface to ensure the user can initiate the automatic locking of a reservation and instantaneously select and confirm the locked reservation, for example, with a single click.

In yet other embodiments, the reservation system may function as an agent on behalf of a customer in order to automatically acquire and/or otherwise lock-in an airline ticket and/or reservation on behalf of the customer, such as based on prior general instructions (i.e. criteria) received from the customer related to purchasing an airline ticket instructions for locking-in an airline reservation. The automatic locking-in may be locked-in or for a limited amount of time, after which the locking-in and/or reservation may be released. Thus, in some embodiments such advice may be provided to users as part of an interactive response to a customer request, while in other situations the providing of the advice may be automatically initiated. When acting as an agent on behalf of customers, the reservation system may employ algorithms that effectively hedge or otherwise limit exposure to loss based on predicted future prices (e.g., by purchasing some but not all of multiple items at a current price even when the predicted future price is lower in order to minimize the risk of the actual future prices being higher than the current price). As another example, the various algorithms may assist in predicting trends in prices over a period of time for specific airline tickets and/or airline reservations and thereby provide notifications that enable a customer to immediately take action in such a manner as to benefit from such trends.

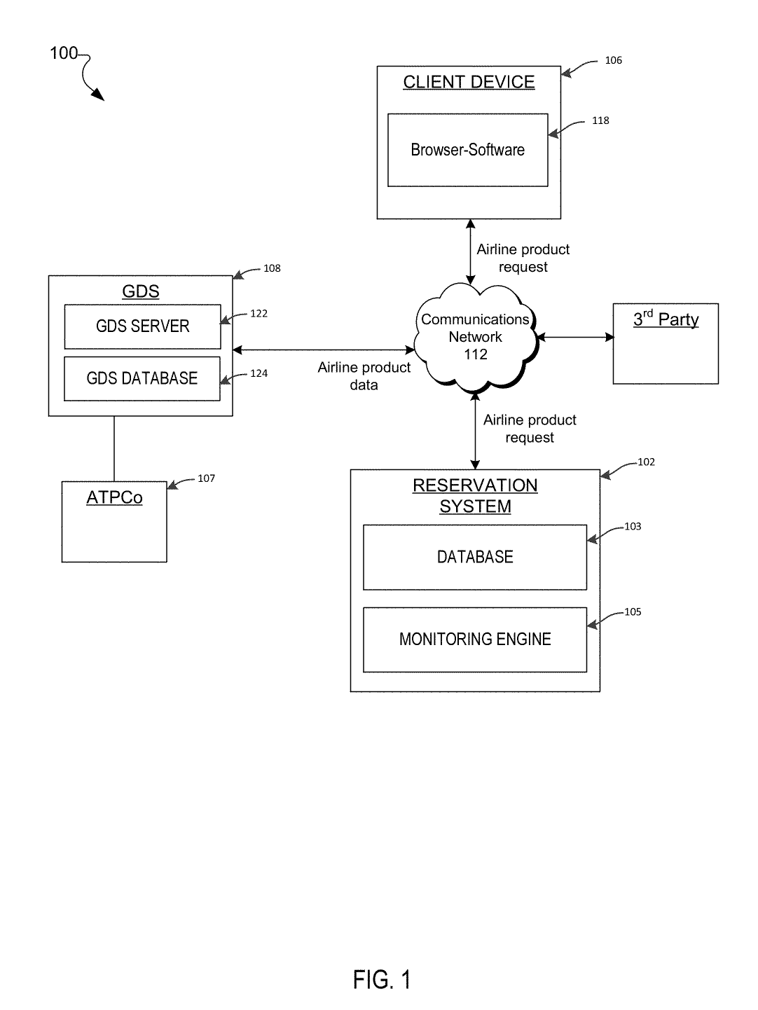

FIG. 1 illustrates one example of a computing architecture 100 for generating and displaying graphical user-interface for reducing the time required to purchase airline tickets and/or airline reservations, according to one embodiment. Generally, the computing architecture 100 include various systems functioning together in the gathering, transmitting, requesting, and/or manipulating travel and/or airline related information and price related information for airline products. In the illustrated embodiment, the computing architecture 100 includes a reservation system 102 that employs one or more algorithms to automatically search for airline fares and prices and/or automatically locks-in air travel reservations and itineraries on behalf of customers.

The reservation system 102 includes a database and/or data store 103 (or some other database architecture including those embodied in a single database or multiple databases of the same or differing platforms) that is used to store, among other information, data relating to airline tickets and/or airline reservation purchases, and in particular to air travel reservation lock-ins made for and/or by customers. For example, such information may include details regarding a specific flight or specific series of flights of an air travel itinerary and any associated pricing of such flights. The information may also include lock-in information, which relates to details regarding the airfare of a locked-in air travel itinerary.

The reservation system 102 further includes a monitoring engine 105 that monitors (e.g., in real-time) airline products based on customer preferences and requests. More specifically, the monitoring engine 105 monitors pricing and availability information for airline products. For example, the monitoring engine 105 may monitor a specific airline product to determine when the price point of the product meets a certain threshold (e.g., is lower than a certain amount). As another example, with regards to air travel itinerary lock-ins, a price detection may occur upon detecting a matching air travel itinerary that has been subsequently purchased at a lower priced airfare. Price detection information involves information memorializing an instance in which a purchased product (such as a locked-in airline ticket) matches a subsequently purchased airline product and where the subsequently purchased airline product was purchased at a lower price than the first product.

To facilitate in the monitoring, validation, and locking-in of airline ticket prices and/or airline reservations, the reservation system 102 may communicate with a Global Distribution System (“GDS”) 108 to synchronize external airline ticket and/or airline reservation pricing and locking-in information. Generally speaking, the GDS 108 is an automated system that provides information on travel-related products such as airline travel, hotel rooms, rental cars and other travel products. In the illustrated embodiment, the GDS 108 includes an external GDS server 150 and GDS database 152 that function together to provide real-time flight information and lock-in information for airline products via the communications network 112. In the illustrated example, the GDS 108 external GDS 108 includes external GDS server 122 and GDS database 124.

A client device 106 allows for online communication with the reservation system 102 through communications network 112, which may be the Internet, an intranet, and Ethernet network, a wireline network, a wireless network, and/or another communication network. Additionally, the client network 106 includes network-enabled devices, such as web-browser software 118 for communication over the communications network 112 (e.g., browsing the internet). In one specific embodiment, the client device may be a personal computer, work station, mobile device, mobile phone, tablet device, processor, and/or other processing device capable of implementing and/or executing processes, software, applications, etc. Additionally, the one or more client device(s) 206 may include one or more processors that process software or other machine-readable instructions and may include a memory to store the software or other machine-readable instructions and data.

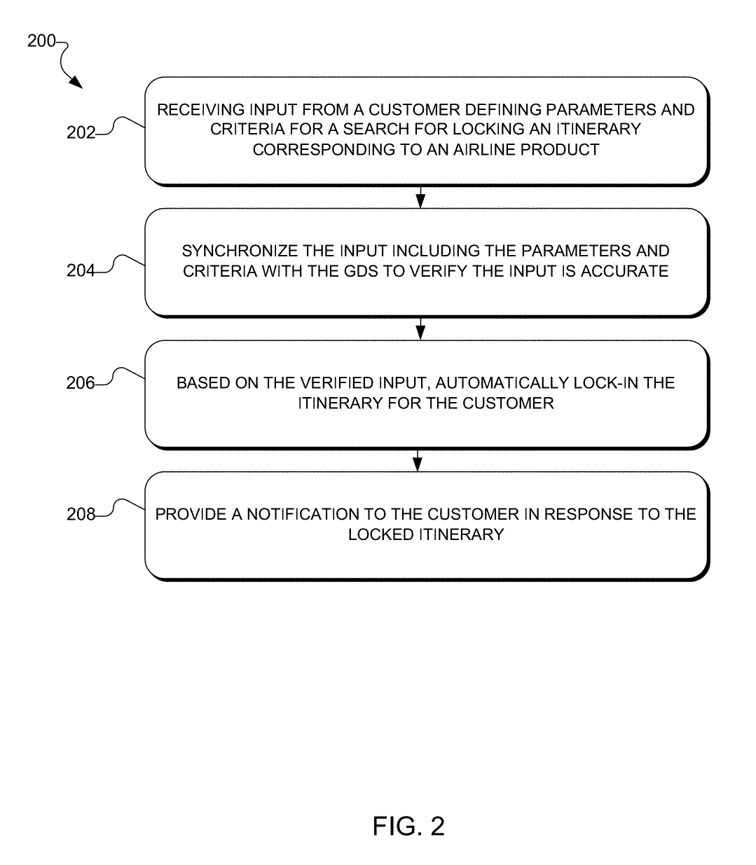

Referring now to FIG. 2 and with reference to FIG. 1, an illustrative process 200 for monitoring and locking airline products is provided. Referring initially to FIG. 2, process 200 begins with receiving input from a customer including parameters and criteria for locking and/or otherwise purchasing some type of airline product (operation 202). In one embodiment and with reference to FIG. 1, the reservation system 102 may generate a series of interactive interfaces/input forms (e.g. a user-interface or graphical user-interface (GUI)) that include interactive elements, such as buttons, forms, activity logs, fields, streaming capabilities, selections, inputs, streams, images, etc., charts, for displaying various aspects of airline products. A user may interact with the client device 106 provide input searching for one or more flight itineraries, a selection of an airline ticket at a particular price point, and provide any parameters or set of criteria to which the customer would like the ticket to be purchased, or otherwise maintained. For example, a customer may provide a maximum or minimum price point at which a customer is willing to purchase an airline product. Additionally, a customer may provide input articulating a time window during which an airline product must be purchased or otherwise locked-in. All of such input is stored in the database of the reservation system 102.

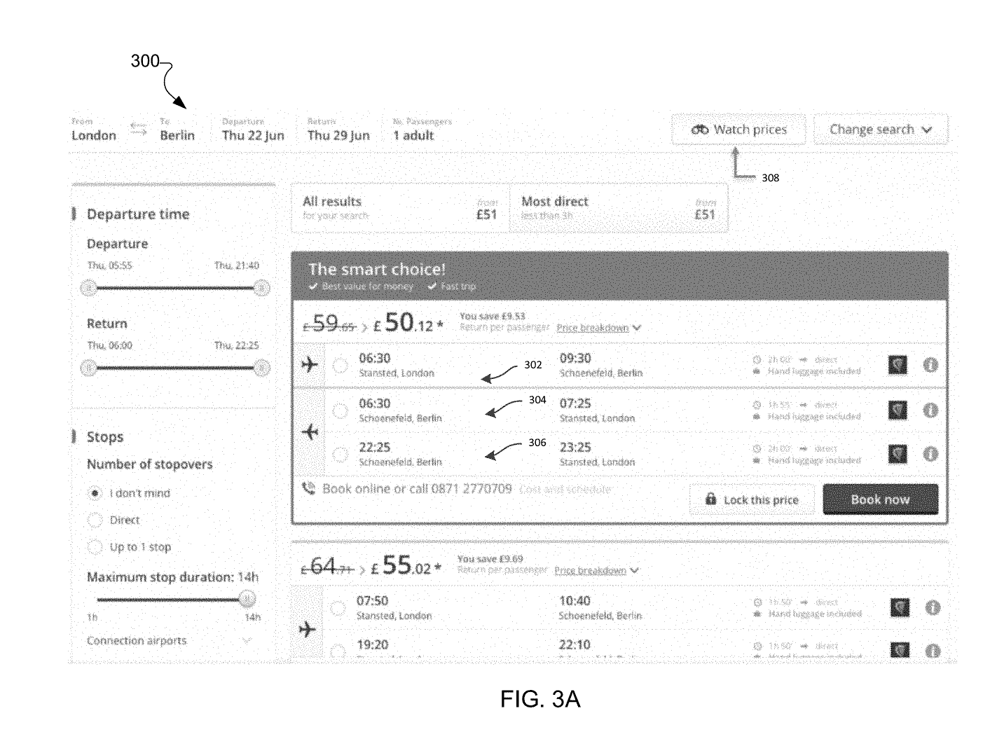

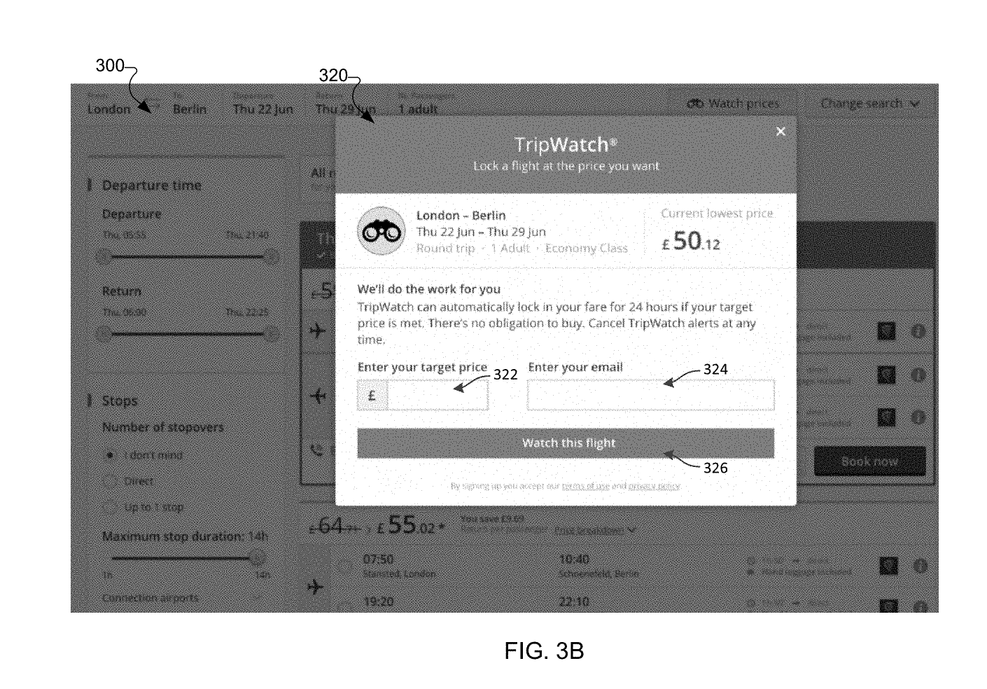

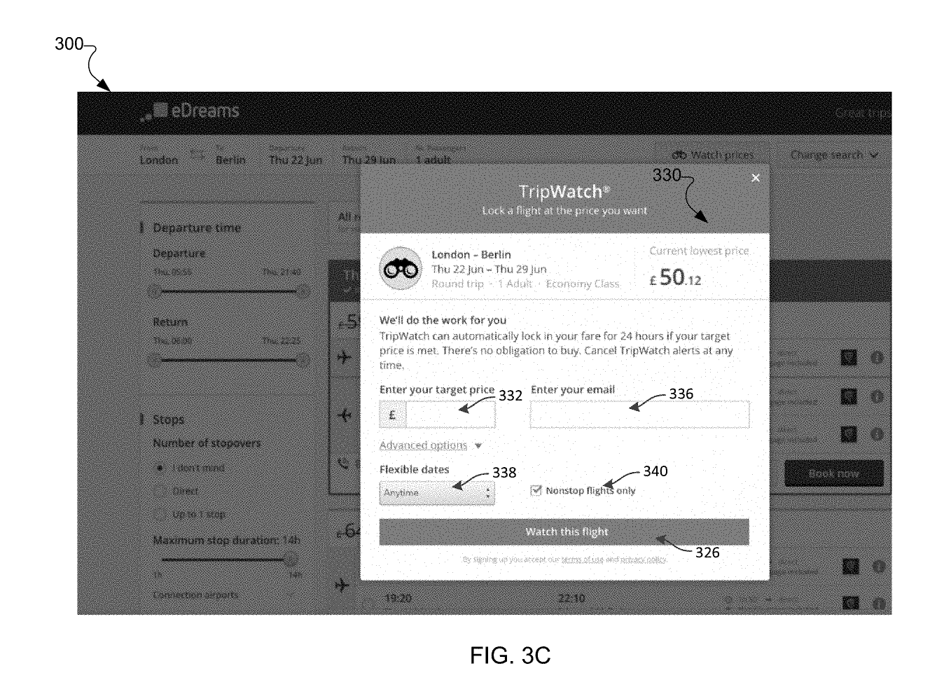

FIGS. 3A-3C illustrate example graphical-user interfaces that may be used to monitor and lock-in airline tickets and related products in an efficient and speedy manner. Referring initially to FIG. 3A, a graphical user-interface 300 is provided that illustrates various airline reservations at 302, 304, and 306, that allow a user to select and reserve an airline ticket for travel between London and Berlin. Under a normal scenario, a user interested in determining whether there were better pricing options available for the ticket would have to select one of the proposed reservations (i.e., 302, 304, or 306) and navigate through a series of additional graphical user-interface screens (not shown) in order to reserve or otherwise purchase the ticket. Then, the user would have to perform additional searching to see if any additional tickets at better prices existed.

The configuration of the various components in the graphical-user interface 300 informs the user in an more efficient manner than existing systems. Users gain a significant advantage by seeing the series of reservations (i.e., 302, 304, and 306) while at the same time being able to see a “TripWatch” button 308 that allows the user to initiate a process that automatically locks in an airline ticket or reservation at a user-specified price. Thus, the user can select a reservation 302, 304, and or 306 and immediately select the “TripWatch” button 308 to automatically monitor the reservation and ultimately select it in the event that the reservation meets the user's criteria. Without the “TripWatch” button 308, the user could not immediately start such a process. Moreover, displaying the “TripWatch” button 308 in such a specific region on the graphical user-interface 300 conveys the ability to automatically lock reservations in an intuitive manner. Thus, users can reserve airline tickets at specific prices in a more efficient and streamlined manner.

In response to selecting the “TripWatch” button 308, a graphical user-interface 320 may be generated that allows a user to input parameters, as illustrated in FIG. 3B. As illustrated, a user may interact with various components 322 to provide parameter input, such as a price range (including a minimum and maximum) that a user is willing to pay for the airline ticket. The user may also provide demographic and/or other personal information such as an email, as illustrated at 324. Upon finishing, the user may select a button “watch this flight” to initiate the monitoring of the airline reservation at 326.

FIG. 3C provides another example of a graphical user-interface 330 that may be generated that allows a user to input parameters. In addition to pricing information, at 332 and 334, and demographical information at 336, a user may provide other parameter information, such as whether the user is flexible on dates, or whether the user prefers non-stop flights at 338 and 340. Upon finishing, the user may select a button “watch this flight” to initiate the monitoring of the airline reservation at 326.

In FIG. 3B and FIG. 3C, the graphical-user interface 320 and 330, respectively, are provided as an overlay and/or interstitial of the graphical-user interface 300. Generating the user-interfaces in such a manner ensures that the user is always connected to the initial reservation select and can easily reference the selected reservation. Moreover, the presentation of only a single graphical user-interface for capturing input corresponding to the reservation ensures fast and accurate monitoring of the reservation, thereby ensuring that the user is more likely to obtain the reservation according to his/her desired input.

Referring again to FIG. 2, once the input containing the parameters and criteria qualifying the procurement of the airline product has been received at the various interfaces, the reservation system synchronizes the provided input with information of the GDS to insure that the data is accurate (operation 204). Then, based on the synchronized data, an applicable airline product is automatically locked-in (operation 206). Stated differently, the reservation system 102 automatically locks in the airline product, such as an airline ticket reservation, in accordance with the parameters and criteria provided by the user. Referring to FIG. 1, the monitoring engine 105 of the reservation system 102 continually monitors and/or otherwise analyzes real-time and/or historic pricing information and/or other airline information, including information across all airline cabin classes and pricing buckets to identify the applicable airline product.

Referring again to FIG. 2, one or more notifications are provided to the applicable customer in response to the locked itinerary (operation 208). Referring to FIG. 1, the reservation system 102 generates notifications in response to locked airline products. Alternatively, the reservation system 102 may generate a notification when a parameter corresponding to a customer and a particular airline product has been met or satisfied. In another example, the reservation system may generate a series of notifications that indicate to the user whether the current price is generally a good price, average price, or bad price. In another example, the reservation system may provide a notification that indicates the customer should purchase the ticket and/or reservation immediately due to immediate predicted future price increases, or delay due to predicted future price drops. In other embodiments, the provided notifications may be provided to users in the form of an active alert, such as alerting potential customers with current and/or predicted future pricing information of an airline ticket and/or airline reservation. For example, the reservation system may alert a potential customer when a current price for the airline ticket and/or reservation satisfies a pre-defined price threshold. In yet another example, the price-lock may occur, and thus a notification may be generated, at market level, wherein a specific itinerary may be monitored and matched to an itinerary/price in a user-specified geographic location. Any of such notifications may be provided to users via the client device 106.

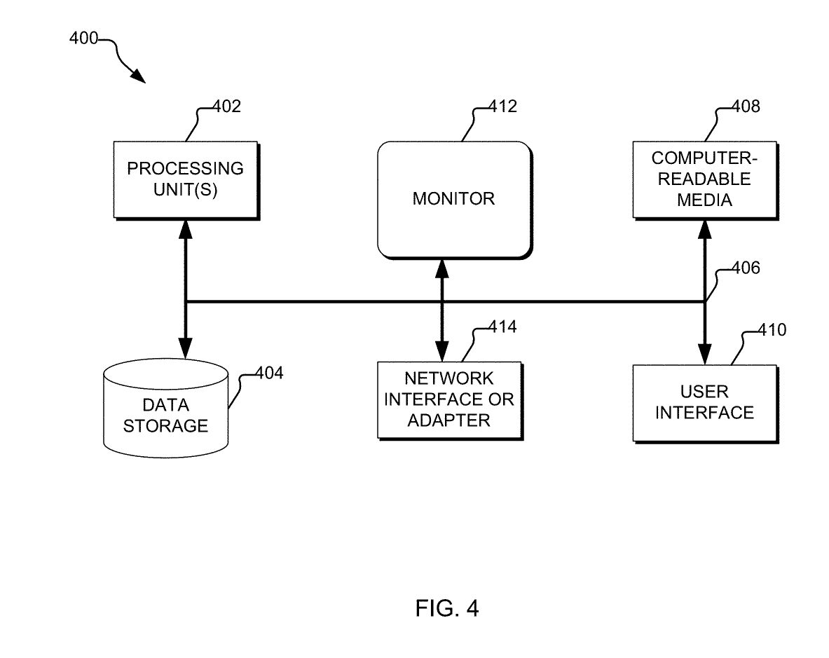

FIG. 4 illustrates an example of a suitable computing and networking environment 400 that may be used to implement various aspects of the present disclosure described in FIGS. 1-2, such as the reservation system 102. As illustrated, the computing and networking environment 400 includes a general purpose computing device 400, although it is contemplated that the networking environment 400 may include one or more other computing systems, such as personal computers, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments that include any of the above computing systems or devices, and the like.

Components of the computer 400 may include various hardware components, such as a processing unit 402, a data storage 404 (e.g., a system memory), and a system bus 406 that couples various system components of the computer 400 to the processing unit 402. The system bus 406 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 400 may further include a variety of computer-readable media 408 that includes removable/non-removable media and volatile/nonvolatile media, but excludes transitory propagated signals. Computer-readable media 408 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the computer 400. Communication media includes computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The data storage or system memory 404 includes computer storage media in the form of volatile/nonvolatile memory such as read only memory (ROM) and random access memory (RAM). A basic input/output system (BIOS), containing the basic routines that help to transfer information between elements within the computer 400 (e.g., during start-up) is typically stored in ROM. RAM typically contains data and/or program modules that are immediately accessible to and/or presently being operated on by processing unit 402. For example, in one embodiment, data storage 404 holds an operating system, application programs, and other program modules and program data.

Data storage 404 may also include other removable/non-removable, volatile/nonvolatile computer storage media. For example, data storage 404 may be: a hard disk drive that reads from or writes to non-removable, nonvolatile magnetic media; a magnetic disk drive that reads from or writes to a removable, nonvolatile magnetic disk; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media, described above and illustrated in FIG. 4, provide storage of computer-readable instructions, data structures, program modules and other data for the computer 400.

A user may enter commands and information through a user interface 410 or other input devices such as a tablet, electronic digitizer, a microphone, keyboard, and/or pointing device, commonly referred to as mouse, trackball or touch pad. Other input devices may include a joystick, game pad, satellite dish, scanner, or the like. Additionally, voice inputs, gesture inputs (e.g., via hands or fingers), or other natural user interfaces may also be used with the appropriate input devices, such as a microphone, camera, tablet, touch pad, glove, or other sensor. These and other input devices are often connected to the processing unit 402 through a user interface 410 that is coupled to the system bus 406, but may be connected by other interface and bus structures, such as a parallel port, game port or a universal serial bus (USB). A monitor 412 or other type of display device is also connected to the system bus 406 via an interface, such as a video interface. The monitor 412 may also be integrated with a touch-screen panel or the like.

The computer 400 may operate in a networked or cloud-computing environment using logical connections of a network interface or adapter 414 to one or more remote devices, such as a remote computer. The remote computer may be a personal computer, a server, a router, a network PC, a peer device or other common network node, and typically includes many or all of the elements described above relative to the computer 400. The logical connections depicted in FIG. 4 include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computer 400 may be connected to a public and/or private network through the network interface or adapter 414. In such embodiments, a modem or other means for establishing communications over the network is connected to the system bus 406 via the network interface or adapter 414 or other appropriate mechanism. A wireless networking component including an interface and antenna may be coupled through a suitable device such as an access point or peer computer to a network. In a networked environment, program modules depicted relative to the computer 400, or portions thereof, may be stored in the remote memory storage device.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the disclosure and are thus within the spirit and scope of the present disclosure. From the above description and drawings, it will be understood by those of ordinary skill in the art that the particular embodiments shown and described are for purposes of illustrations only and are not intended to limit the scope of the present disclosure. References to details of particular embodiments are not intended to limit the scope of the disclosure

What is claimed is:

1. accept an airline product on a graphical-user interface
at least one reservation system comprising a memory storing instructions for generating a reservation; and
one or more computing devices that execute the instructions to:
generate a graphical user-interface dynamically displaying a first indicator of an airline product in one of a plurality of locations in a reservation display region, each location in the reservation display region corresponding to a variable price of an airline product available for reservation in an external airline reservation system;
receive input from a user including criteria to accept the airline product within the external airline reservation system;
verify the input received from the user is valid at a global distribution system maintaining real-time airline product data;
when the input is verified, automatically accept the airline product in the external airline reservation system; and
dynamically display an indication of an acceptance of the airline product in in relation to the first indicator of the airline product, such that when the variable price corresponding to the airline product changes thereby causing the first indicator to change, the indication of the acceptance of the airline product in relation to the first indicator does not change.

2. The system of claim 1 wherein the one more computing devices is further configured to generate for display on the graphical-user interface a series of notifications that indicate whether the airline product is at an acceptable price.

3. The system of claim 1, wherein the input provided by the user includes a maximum or minimum price point at which a customer is willing to purchase the airline product and a time window during which an airline product must be accepted.

4. The system of claim 3, wherein the one or more computing devices is further configured to monitor the airline product to determine when a price corresponding to the airline product satisfies a threshold defined as the maximum or minimum price.

5. The system of claim 1, wherein the one or more computing devices is further configured to display a product selection region on the graphical user-interface comprising interactive components for receiving the input from the user.

6. The system of claim 1, wherein verifying the input is valid comprises synchronizing the input with portions of the real-time airline product data to determine a match.
accept an airline product on a graphical-user interface
generating, using one or more computing devices, a graphical user-interface dynamically displaying a first indicator of an airline product in one of a plurality of locations in a reservation display region, each location in the reservation display region corresponding to a price of an airline product available for reservation in an external airline reservation system;
receiving, using the one or more computing devices, input from a user including criteria for to accept an airline product within the external airline reservation system;
verifying, using the one or more computing devices, the input received from the user is valid at a global distribution system maintaining real-time airline product data; and
when the input is verified, automatically accept the airline product in the airline reservation system; and
dynamically displaying an indication of an acceptance of the airline product in in relation to the first indicator of the airline product, such that when the variable price corresponding to the airline product changes thereby causing the first indicator to change, the indication of the acceptance of the airline product in relation to the first indicator does not change.

8. The method of claim 7, further comprising generating for display on the graphical-user interface a series of notifications that indicate whether the airline product is at an acceptable price.

9. The method of claim 7, wherein the input provided by the user includes a maximum or minimum price point at which a customer is willing to purchase the airline product and a time window during which an airline product must be accepted.

10. The method of claim 9, further comprising monitoring the airline product to determine when a price corresponding to the airline product satisfies a threshold defined as the maximum or minimum price.

11. The method of claim 7, further comprising displaying a product selection region on the graphical user-interface comprising interactive components for receiving the input from the user.

12. The method of claim 7, wherein verifying the input is valid comprises synchronizing the input with portions of the real-time airline product data to determine a match.

13. A non-transitory computer readable storage medium having embodied thereon a program executable by one or more computing devices, the program including instructions to accept an airline product on a graphical-user interface, the instructions comprising
generating, using one or more computing devices, a graphical user-interface dynamically displaying a first indicator of an airline product in one of a plurality of locations in a reservation display region, each location in the reservation display region corresponding to a variable price of an airline product available for reservation in an external airline reservation system;
receiving, using the one or more computing devices, input from a user including criteria for to accept an airline product within the external airline reservation system;
verifying, using the one or more computing devices, the input received from the user is valid at a global distribution system maintaining real-time airline product data; and
when the input is verified, automatically accept the airline product in the airline reservation system; and
dynamically display an indication of an acceptance of the airline product in in relation to the first indicator of the airline product, such that when the variable price corresponding to the airline product changes thereby causing the first indicator to change, the indication of the acceptance of the airline product in relation to the first indicator does not change.

14. The non-transitory computer readable storage medium of claim 13, further comprising generating for display on the graphical-user interface a series of notifications that indicate whether the airline product is at an acceptable price.

15. The non-transitory computer readable storage medium of claim 13, wherein the input provided by the user includes a maximum or minimum price point at which a customer is willing to purchase the airline product and a time window during which an airline product must be accepted.

16. The non-transitory computer readable storage medium of claim 15, further comprising monitoring the airline product to determine when a price corresponding to the airline product satisfies a threshold defined as the maximum or minimum price.

17. The non-transitory computer readable storage medium of claim 13, further comprising displaying a product selection region on the graphical user-interface comprising interactive components for receiving the input from the user.

18. The non-transitory computer readable storage medium of claim 13, wherein verifying the input is valid comprises synchronizing the input with portions of the real-time airline product data to determine a match.
